(19) United States
(12) Patent Application Publication
(10) Pub. No.: US 2015/0127387 A1
(43) Pub. Date: May 7, 2015

(54) COMPUTER-IMPLEMENTED RETIREMENT INCOME SOLUTION

(71) Applicant: Jeff M. Atwell, Hillsboro, TX (US)

(72) Inventor: Jeff M. Atwell, Hillsboro, TX (US)

(73) Assignee: American National Bank of Texas, Terrell, TX (US)

(21) Appl. No.: 14/481,685

(22) Filed: Sep. 9, 2014

Related U.S. Application Data
(60) Provisional application No. 61/878,402, filed on Sep. 16, 2013.
(60) Provisional application No. 62/039,749, filed on Aug. 20, 2014.

(51) Int. Cl. G06Q 40/06

(52) U.S. Cl. CPC G06Q 40/06; G06Q 40/08
USPC 705/4

(57) ABSTRACT

A system and method for making retirement income last until death can be offered to retirement plans. A participant can invest money with a right to purchase an annuity. The participant can receive monthly income from the annuity during retirement.

### RELATED APPLICATIONS

This application claims priority to, and incorporates by reference, U.S. Provisional Application No. 61/878,402 filed Sep. 16, 2013, and U.S. Provisional Application Ser. No. 62/039,749 filed Aug. 20, 2014.

### FIELD

The disclosure relates generally to a wealth management. The disclosure specifically relates to a computer-implemented solution for making income last until death.

### BACKGROUND

Defined benefit plans have been declining in numbers for many years resulting in companies shifting investment risk and the burden of saving for retirement to participants. As a result, many individuals are at or near retirement without adequate retirement savings. In addition, an individual can expect to live as long in retirement as they did working. This has placed another burden on individuals, longevity risk, outliving their retirement income. Many people do not have adequate retirement savings or are not on track to accumulate adequate retirement savings. If an individual has accumulated adequate retirement savings, they face the challenge of how to manage their savings in a manner to provide adequate income and not outlive their savings.

Retirees in distributed contribution plans risk running out of money before they die. Reasons that a retiree can run out of money from their retirement plan are the withdrawal rate, their longevity, the sequence of return, inflation, and their cognitive impairment. Potential solutions for a retiree running out of money from their plan include traditional annuities, guaranteed minimum withdrawal benefit (GMWB) plans, deferred annuities, retirement income and managed payout funds, and managed accounts. However, none of the potential solutions address all of the reasons that a retiree can run out of money.

Many retirement providers have developed online tools and education material to assist participants in evaluating their retirement savings goal or needs to their current savings rate, commonly called a gap analysis. Many individuals do not utilize these tools. Several retirement plan providers have developed products to assist participants with managing their longevity risk. These products or investments provide participants with the ability to invest in a fund or funds that will pay the participant an income for life at the time they retire. There are several issues associated with these options which will create significant fiduciary issues in the future. Primarily these products are not portable or are very limited in their portability. As a result, if the employer changes the platform providing the benefit or if the fund associated with the income benefit needs to be replaced, the participant will lose their benefit, a potential fiduciary problem. There is not a feasible solution in the market place to provide retirement plan participants and individual retirement account (IRA) holders with information on whether or not they are on track for accumulating adequate retirement savings or a solution to insure they do not outlive their retirement income once they are in or at retirement. Retirement plan sponsors face concerns such as fiduciary risk, portability (both at the plan level and the participant level), cost, investment risk, and disclosures.

It would therefore be advantageous to have a retirement solution that is portable and allows more flexibility in choosing the amount of retirement savings to convert to a monthly income at retirement.

### SUMMARY

An embodiment is a computer-implemented method for providing annuity benefits throughout retirement of a participant comprising entering a participant's information into a database on a bank computer capable of sending and receiving data, wherein the bank computer is connected to a bank's computer network; utilizing the participant's information entered into the database on the bank computer connected to the bank's computer network to perform computer-based calculations of the amount of time that the participant will need retirement funds; determining by computer-based calculations using existing annuity purchase rates, the amount of money from the participant's existing funds needed for the purchase of an annuity that will provide an income throughout retirement of the participant in combination with any remaining existing funds of the participant; transferring at least a portion of the participant's existing funds electronically to the bank computer connected to the bank's computer network; obtaining an annuity commitment from an insurer; wherein annuity purchase rates were obtained electronically from at least one insurer; providing the participant with a right to purchase the annuity at a guaranteed purchase rate; and providing the participant with monthly retirement funds throughout retirement if the annuity was purchased.

In another embodiment, a bank acts as a fiduciary at the time of annuity purchase. In yet another embodiment, the computer-based calculations to determine the amount of money from the participant's existing funds needed for the purchase of the annuity comprise life expectancy data, current retirement balance, and retirement contributions. In a further embodiment, the annuity is portable. In another embodiment, the participant is provided with an annual report.

An embodiment is a computer-implemented method for providing annuity benefits throughout retirement of a participant comprising entering a participant's information into a database on a bank computer capable of sending and receiving data, wherein the bank computer is connected to a bank's computer network; utilizing the participant's information entered into the database on the bank's computer connected to the bank's computer network to perform computer-based calculations of the amount of time that the participant will need retirement funds; creating a trust for the participant, wherein the trust is located on a bank computer connected to the bank's computer network; determining by computer-based calculations the amount of money from the participant's existing funds to transfer to the trust for the purchase of an annuity that will provide an income throughout retirement of the participant in combination with any remaining existing funds of the participant; transferring at least a portion of the participant's existing funds electronically to the trust located on the bank computer connected to the bank's computer network; obtaining an annuity commitment to the trust from an insurer; wherein annuity purchase rates were obtained electronically from at least one insurer; providing the participant with a right to purchase the annuity at a guaranteed purchase rate; and providing the participant with monthly retirement funds throughout retirement if the annuity was purchased. In an embodiment, a bank serves as a fiduciary of the trust. In another embodiment, the computer-based calculations to determine the amount of time that a participant will need retirement funds utilize life expectancy data. In another embodiment, the computer-based calculations to determine the amount of money from the participant's existing funds to place in the trust for the purchase of the annuity comprise life expectancy data, current retirement balance, and retirement contributions. In an embodiment, determining the amount of money from the participant's existing funds to place in the trust for a purchase of an annuity considers how much money needs to be paid out during retirement. In another embodiment, the amount of existing funds that the participant places in the trust is from the participant's retirement account. In an embodiment, the annuity is portable. In yet another embodiment, the participant is provided with an annual report. In another embodiment, the annual report includes a gap analysis. In yet another embodiment, the trustee monitors annuity performance.

An embodiment is a computer-implemented system for providing annuity benefits throughout retirement of a participant comprising a bank's computer network comprising participant information in a database on a bank computer capable of sending and receiving data, wherein the bank computer capable of sending and receiving data, wherein the bank computer is connected to a bank's computer network; computer-based calculations of the amount of time that the participant will need retirement funds; computer-based calculations of the amount of money from the participant's existing funds to transfer to the trust for the purchase of an annuity that will provide an income throughout retirement of the participant in combination with any remaining existing funds of the participant; a trust, located on a bank computer connected to the bank's computer network, wherein the trust electronically receives at least a portion of the participant's existing funds; an annuity, wherein an annuity commitment was obtained to the trust from an insurer, wherein annuity purchase rates were obtained electronically from at least one insurer; and a monthly disbursement of funds throughout retirement if the annuity was purchased. In an embodiment, a bank is a fiduciary of the trust. In another embodiment, the computer-based calculations the amount of time that a participant will need retirement funds utilize life expectancy data. In yet another embodiment, the computer-based calculations of the amount of money from the participant's existing funds to place in the trust for the purchase of the annuity comprise life expectancy data, current retirement balance, and retirement contributions. In still another embodiment, determining the amount of money from the participant's existing funds to place in the trust for a purchase of an annuity considers how much money needs to be paid out during retirement. In an embodiment, the amount of money that the participant is placing in the trust is from the participant's retirement account. In another embodiment, the annuity is portable. In another embodiment, the participant is provided with an annual report. In still another embodiment, the annual report includes a gap analysis. In another embodiment, the trustee monitors annuity performance.

The foregoing has outlined rather broadly the features of the present disclosure in order that the detailed description that follows can be better understood. Additional features and advantages of the disclosure will be described hereinafter, which form the subject of the claims.

### BRIEF DESCRIPTION OF THE DRAWINGS

In order that the manner in which the above-recited and other enhancements and objects of the disclosure are obtained, a more particular description of the disclosure briefly described above will be rendered by reference to specific embodiments thereof which are illustrated in the appended drawings. Understanding that these drawings depict only typical embodiments of the disclosure and are therefore not to be considered limiting of its scope, the disclosure will be described with additional specificity and detail through the use of the accompanying drawings in which:

FIG. 1 depicts a flowchart of events in the retirement income solution.

FIG. 2 depicts a chart of a computer-implemented system for providing annuity benefits throughout retirement for a participant.

FIG. 3 depicts a website for entering information to determine how to reach retirement goals.

FIG. 4 depicts a report providing guidance on how to reach retirement goals.

### DETAILED DESCRIPTION

The particulars shown herein are by way of example and for purposes of illustrative discussion of the preferred embodiments of the present disclosure only and are presented in the cause of providing what is believed to be the most useful and readily understood description of the principles and conceptual aspects of various embodiments of the disclosure. In this regard, no attempt is made to show structural details of the disclosure in more detail than is necessary for the fundamental understanding of the disclosure, the description taken with the drawings making apparent to those skilled in the art how the several forms of the disclosure can be embodied in practice.

The following definitions and explanations are meant and intended to be controlling in any future construction unless clearly and unambiguously modified in the following examples or when application of the meaning renders any construction meaningless or essentially meaningless. In cases where the construction of the term would render it meaningless or essentially meaningless, the definition should be taken from Webster's Dictionary 3^{rd} Edition.

In an embodiment, a group trust (the “Trust”) can be offered to retirement plans (for example 401(a), 401(k), 457 and potentially 403(b) plans). In an embodiment, a bank would act as trustee of the Trust. As trustee, the bank would select one or more insurers to commit to the issuance of individual immediate annuities to participants in the participating plans at a predetermined annuity purchase rate. In an embodiment, in its role as trustee, the bank would be responsible for the prudent selection and monitoring of the insurer(s) and the annuity contracts, the negotiation and periodic renegotiation of the annuity purchase rates, and for providing each plan participant who elected to participate in the group trust an annual gap analysis.

In an embodiment, the plan can be offered to participants. In an embodiment, the participants can have a 401(a), 401(k), 457, 403(b) or IRA. The bank would select one or more insurers to commit to the issuance of individual immediate annuities to a participant in a participating plan at a predetermined annuity purchase rate. In an embodiment, the bank would be responsible for the prudent selection and monitoring of the insurer(s) and the annuity contracts, the negotiation and periodic renegotiation of the annuity purchase rates, and for providing the individual plan participant who elected to participate an annual gap analysis.

In an embodiment, a trust can be offered to retirement plans (for example 401(a), 401(k), 457 and potentially 403(b) plans). In an embodiment, the trust is an individual trust. In an embodiment, the bank would act as trustee of the individual trust. As trustee, the bank would select one or more insurers to commit to the issuance of individual immediate annuities to a participant in a participating plan at a predetermined annuity purchase rate. In an embodiment, in its role as trustee, the bank would be responsible for the prudent selection and monitoring of the insurer(s) and the annuity contracts, the negotiation and periodic renegotiation of the annuity purchase rates, and for providing the individual plan participant who elected to participate in the trust an annual gap analysis.

In an embodiment, a trust is not used. Examples of alternatives to a trust include, but are not limited to, investing in alternate assets such as corporations, real estate, metals, and debt.

In an embodiment, the features of the program include but are not limited to the following: 1) the bank, as trustee of the Trust, would select an insurer based on a number of criteria, including financial strength and reputation, and annuity purchase rates and benefits; 2) the bank as trustee would continuously evaluate the insurer and other insurers in terms of financial strength and reputation, continuously monitor available annuity purchase rates in order to acquire, for the benefit of participants, favorable terms and rate locks, and periodically perform the gap analysis for participants; 3) the insurer would issue a commitment to the Trust pursuant to which participants of plans that participated in the Trust would be eligible to purchase an individual annuity at annuity purchase rates guaranteed for a predetermined period; 4) each participating employer would select the Trust as an investment alternative under the plan to make it available to participants; 5) participants would invest a nominal portion of their account balances in the Trust and would be issued an individual commitment certificate guaranteeing the right to purchase an annuity at the negotiated annuity purchase rates and to receive an annual gap analysis. If the Bank as trustee were to negotiate a new annuity purchase rate or replace the insurer that issued the original commitment letter, a new commitment certificate would be issued to the participant. The commitment certificate would constitute a contract right which would be portable; 6) the commitment certificate would essentially constitute an option in favor of a participant. If a participant elected to purchase an annuity, he or she would have the right to do so at the predetermined annuity purchase rate. On the other hand, if the participant so elected, it could forego the right to purchase the annuity. His “investment” in the commitment certificate would be sufficiently nominal that there would be little adverse financial impact if he elected not to purchase the annuity; and 7) if the participant were to change jobs, the participant could (a) leave some or all his or her benefit in the old employer's plan, including the commitment certificate, (b) take a distribution of his benefit, including the commitment certificate, or (c) roll over the assets, including the commitment certificate, into an individual retirement account. If the participant's new employer elected to offer the Trust in its plan, the participant could roll the commitment certificate back into the new employer's plan.

In an embodiment, the trust is an individual trust instead of a group trust. In an embodiment, the features of the program include but are not limited to the following: 1) the bank, as trustee of the individual trust, would select an insurer based on a number of criteria, including financial strength and reputation, and annuity purchase rates and benefits; 2) the bank as trustee would continuously evaluate the insurer and other insurers in terms of financial strength and reputation, continuously monitor available annuity purchase rates in order to acquire, for the benefit of participants, favorable terms and rate locks, and periodically perform the gap analysis for the individual; 3) the insurer would issue a commitment to the trust pursuant to which a participant in the trust would be eligible to purchase an individual annuity at annuity purchase rates guaranteed for a predetermined period; 4) each participating employer would select the trust as an investment alternative under the plan to make available to the participant; 5) the participant would invest a nominal portion of his or her account balance in the trust and would be issued an individual commitment certificate guaranteeing the right to purchase an annuity at the negotiated annuity purchase rates and to receive an annual gap analysis. If the Bank as trustee were to negotiate a new annuity purchase rate or replace the insurer that issued the original commitment letter, a new commitment certificate would be issued to the participant. The commitment certificate would constitute a contract right which would be portable; 6) the commitment certificate would essentially constitute an option in favor of a participant. If a participant elected to purchase an annuity, he or she would have the right to do so at the predetermined annuity purchase rate. On the other hand, if the participant so elected, it could forego the right to purchase the annuity. His “investment” in the commitment certificate would be sufficiently nominal that there would be little adverse financial impact if he elected not to purchase the annuity; and 7) if the participant were to change jobs, the participant could (a) leave some or all his or her benefit in the old employer's plan, including the commitment certificate, (b) take a distribution of his benefit, including the commitment certificate, or (c) roll over the assets, including the commitment certificate, into an individual retirement account. If the participant's new employer elected to offer the trust in its plan, the participant could roll the commitment certificate back into the new employer's plan.

In an embodiment, a trust is not used. In an embodiment, the features of the program include but are not limited to the following: 1) the bank would select an insurer based on a number of criteria, including financial strength and reputation, and annuity purchase rates and benefits; 2) the bank as trustee would continuously evaluate the insurer and other insurers in terms of financial strength and reputation, continuously monitor available annuity purchase rates in order to acquire, for the benefit of participants, favorable terms and rate locks, and periodically perform the gap analysis for the individual; 3) the insurer would issue a commitment pursuant to which a participant would be eligible to purchase an individual annuity at annuity purchase rates guaranteed for a predetermined period; 4) each participating employer would select the plan as an investment alternative under the plan to make available to the participant; 5) the participant would invest a nominal portion of his or her account balance and would be issued an individual commitment certificate guaranteeing the right to purchase an annuity at the negotiated annuity purchase rates and to receive an annual gap analysis. If the Bank were to negotiate a new annuity purchase rate or replace the insurer that issued the original commitment letter, a new commitment certificate would be issued to the participant. The commitment certificate would constitute a contract right which would be portable; 6) the commitment certificate would essentially constitute an option in favor of a participant. If a participant elected to purchase an annuity, he or she would have the right to do so at the predetermined annuity purchase rate. On the other hand, if the participant so elected, it could forego the right to purchase the annuity. His “investment” in the commitment certificate would be sufficiently nominal that there would be little adverse financial impact if he elected not to purchase the annuity; and 7) if the participant were to change jobs, the participant could (a) leave some or all his or her benefit in the old employer's plan, including the commitment certificate, (b) take a distribution of his benefit, including the commitment certificate, or (c) roll over the assets, including the commitment certificate, into an individual retirement account. If the participant's new employer elected to offer the plan in its plan, the participant could roll the commitment certificate back into the new employer's plan.

In an embodiment, the bank would market the program on a “wholesale” basis to broker dealers (“BDs”) and registered investment advisors (“RIAs”), who in turn would market the program to employers and Plan trustees. The Bank would receive a trustee fee under the trust for its on-going monitoring and negotiation services and for the annual gap analysis provided to participants. It is contemplated that the nominal investment by each participant would be sufficient to pay the trustee's fees and expenses. In an embodiment, the trust is an individual trust instead of a group trust.

In an embodiment, a trust is not used. In an embodiment, the Bank would receive a fee for its on-going monitoring and negotiation services and for the annual gap analysis provided to participants. It is contemplated that the nominal investment by each participant would be sufficient to pay the fees and expenses.

In an embodiment, the BDs and RIAs would not receive any up-front compensation but would be entitled to a commission when the participant purchased the annuity. In an embodiment, the bank would track the initial referring BDs and RIAs to ensure that they received this compensation regardless of whether the participant was still with the initial employer or the adviser still worked with that employer. In an embodiment, it is also anticipated that the bank would receive an override (to be negotiated) from the issuer of the annuities when a participant elected to purchase an annuity.

### The Plan

In an embodiment, a participant in a defined contribution plan or an IRA holder is provided with information on the projected value of their retirement savings and the lifetime income the accumulated savings will provide compared to their current income as a result of a computer-implemented plan and method for providing annuity benefits. The service is not tied to a specific platform or investment and can be maintained by the participant regardless of the IRA or 401(k) provider or where the participant transfers their assets among different retirement plan providers. In an embodiment, the employer can pay the fee or the participant or IRA holder can pay the fee either out of their plan assets or personally. The bank will provide the technology to produce the initial analysis, ongoing annual reports, negotiate annuity purchase rates, and complete due diligence on the financial condition of the insurance company issuing the single premium immediate annuity at the time retirement distributions are requested by the participant or IRA holder. In an embodiment, the technology will be internet-based and accessible by personal computer (PC), tablet, or smart phone. In an embodiment, the participant/IRA holder will update their account information annually and in return, receive an updated report indicating the new computer-based projected accumulation value and lifetime income benefits based on current annuity purchase rates. In an embodiment, the bank can provide a report for a given year with retirement income projections as well as a certificate guaranteeing the lifetime annuity income benefits. In an embodiment, an outside company can be used to prepare the reports.

In an embodiment, a participating employer offers the trust as an investment alternative under the plan to make it available to participants. The participant should notify the bank if he or she leaves an employer and transfers his or her 401(k). The participant can change the financial advisor assigned to their certificate.

In an embodiment, a trust is not used and a participating employer offers the plan as an investment alternative and makes it available to participants. The participant should notify the bank if he or she leaves an employer and transfers his or her 401(k). The participant can change the financial advisor assigned to their certificate.

In an embodiment, the participant/IRA holder will pay the bank an initial fee to establish their account and service and an ongoing annual fee to provide the updated annual report. In an embodiment, the initial fee can be $100.00 and the annual renewal fee can be $60.00. In an embodiment, the initial fee is $50.00. In an embodiment, the initial fee is $35.00. In an embodiment, the participant/IRA holder will pay for the service with a credit card. In an embodiment, the participant/IRA holder will pay for the service out of plan assets. In an embodiment, the 401k manager has to authorize payment of the fee for the service from the account balance. In an embodiment, the 401k manager and bank sign an engagement letter before the service is made available to the participant. The IRA holder controls their own account.

In an embodiment, the service can be announced and marketed to the managers of defined contribution assets. The managers will market to their plans and participants through their marketing material and sales force. The sales force will have incentive because this service provides a completive alternative to other platforms offering an income benefit. The service will be announced through various industry publications and media outlets to the general public. Investment advisors will have incentive to promote the service because this will provide them a means of being compensated on assets the participant/IRA holder annuitizes at the time they choose to begin distributions with very little effort on their part. In an embodiment, the managers will have incentive because the assets will end up back with the manager at the time the participant/IRA holder annuitizes. The bank will have recurring annual income while diversifying income resources within the retirement department. As the numbers of subscribers grow, enhancements to the program can be made and better annuity purchase rates can be negotiated.

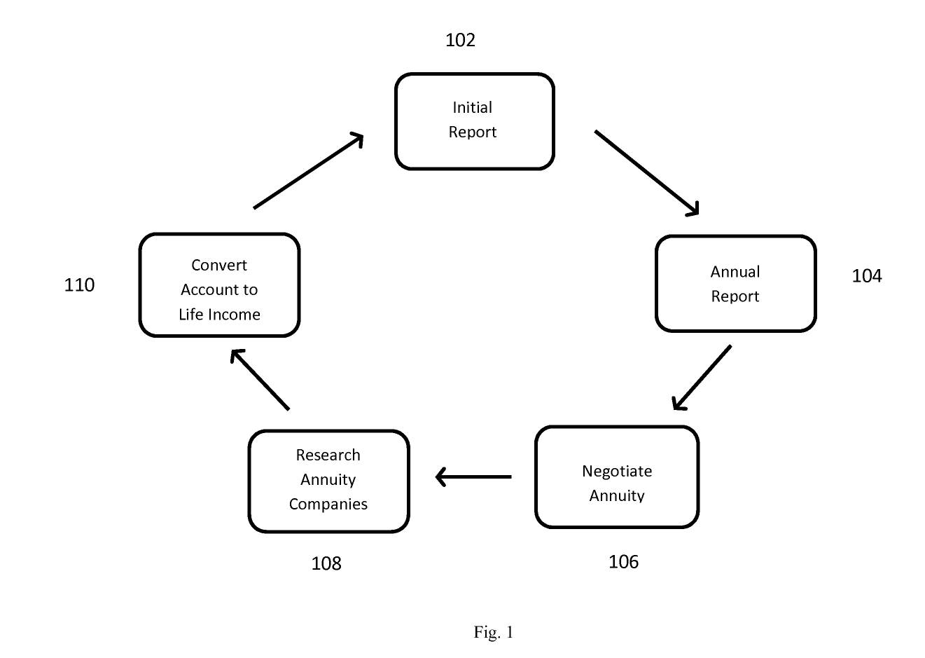

FIG. 1 depicts events included in the plan including 1) computer-based projection of future account values and expected guaranteed retirement income 102; 2) an annual progress report showing how account values and guaranteed income were affected by changes to see if the participant is on track 104; 3) finding the most competitive annuity rates 106; 4) ongoing and consistent research to find the best annuity company 108; and 5) helping the participants transition the accounts they choose into a guaranteed lifetime income for a more secure retirement that is free of market fluctuations and loss 110.

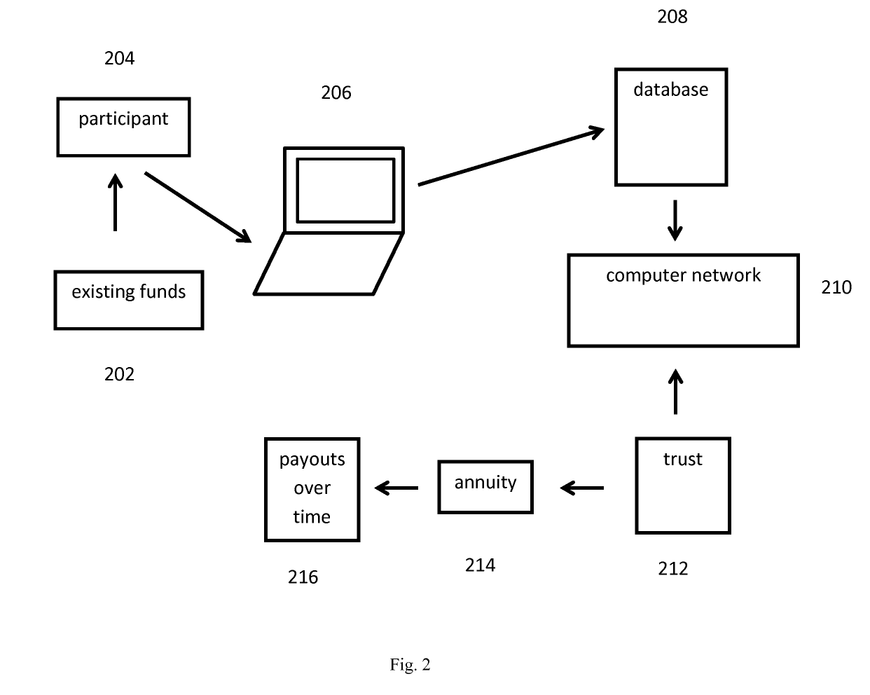

FIG. 2 depicts the system of entering information about the participant 204 on a computer 206 into a database 208 on the bank's computer network 210. The information is used to make computer-based calculations of how much of a participant's existing funds 202 should be placed in a trust 212 and then used to purchase an annuity 214 that will provide payouts 216 throughout retirement of the participant. In an embodiment, a trust is not used.

The bank provides information based on computer-based calculations to a participant to see what kind of retirement is projected. The plan uses computer-based robust financial analytics and Monte-Carlo simulation methods to educate the participant on whether they are likely to meet their retirement income goals.

The analysis uses a participant's specific information such as age, an assumed retirement date, and other facts or assumptions. Assumptions can include but are not limited to current age, current salary, and retirement income goal as a percentage of final salary, desired retirement age, annual inflation rate, 401(k) contribution, salary growth rate, employer contribution, and current 401(k) balance. The analysis uses a computer-based assumption about how long the participant will live to determine how long he or she will need funds in retirement. Along with this, contributions to savings and willingness to take investment risk will be considered in the computer-based calculations to determine how likely it is that what the participant is currently doing and/or might choose to do, will help the participant to achieve his or her retirement planning goals. The probability of the participant reaching his or her goals is computed by making assumptions about several different future investment scenarios, simulating what would happen under each, and expressing this as a percentage.

In an embodiment, retirement income sources that constitute the total projected income can include but are not limited to social security, retirement plans, and pensions. The difference between the retirement income goal and the total projected income is the amount that the bank helps the participant make up for in retirement.

In an embodiment, the options for lifetime income can include lifetime, lifetime with a 10-year period certain, joint lifetime, and joint lifetime with a 10-year period certain. The period certain is the specific amount of period for which the payments will last.

In an embodiment, the participant can make decisions on how much to save and where to invest. In an embodiment, the participant can fully accept the bank's suggestions. In an embodiment, the participant can change the contribution rate and investment directions.

In an embodiment, a group trust is not an investment or an insurance contract. In an embodiment, the ongoing cost to the participant is nominal and the trust eliminates the investment risk. The bank serves as a fiduciary and selects and monitors the annuity providers and negotiates annuity purchase rates. In an embodiment, the bank serves as a fiduciary at the time that the annuity is purchased. In an embodiment, the trust holds the certificate. A participant provides a small deposit to the group trust for the certificate. A participant in the plan has the right to purchase an annuity at a guaranteed rate. The plan is fully portable, assures participants the best pricing, and eliminates complicated disclosures. The bank can optionally provide an annual gap analysis. Gap analysis allows the participant to save outside of the group trust funds.

In an embodiment, the trust is an individual trust instead of a group trust. The individual trust is not an investment or an insurance contract. In an embodiment, the ongoing cost to the participant is nominal and the trust eliminates the investment risk. The bank serves as a fiduciary and selects and monitors the annuity providers and negotiates annuity purchase rates. In an embodiment, the bank serves as a fiduciary at the time that the annuity is purchased. In an embodiment, the trust holds the certificate. A participant provides a small deposit to the trust for the certificate. A participant in the plan has the right to purchase an annuity at a guaranteed rate. The plan is fully portable, assures participants the best pricing, and eliminates complicated disclosures. The bank can optionally provide an annual gap analysis. Gap analysis allows the participant to save outside of the trust funds.

In an embodiment, a trust is not used. In an embodiment, the ongoing cost to the participant is nominal and the investment risk is decreased or eliminated. The bank serves as a fiduciary and selects and monitors the annuity providers and negotiates annuity purchase rates. In an embodiment, the bank serves as a fiduciary at the time that the annuity is purchased. In an embodiment, the trust holds the certificate. A participant provides a small deposit to the trust for the certificate. A participant in the plan has the right to purchase an annuity at a guaranteed rate. The plan is fully portable, assures participants the best pricing, and eliminates complicated disclosures. The bank can optionally provide an annual gap analysis.

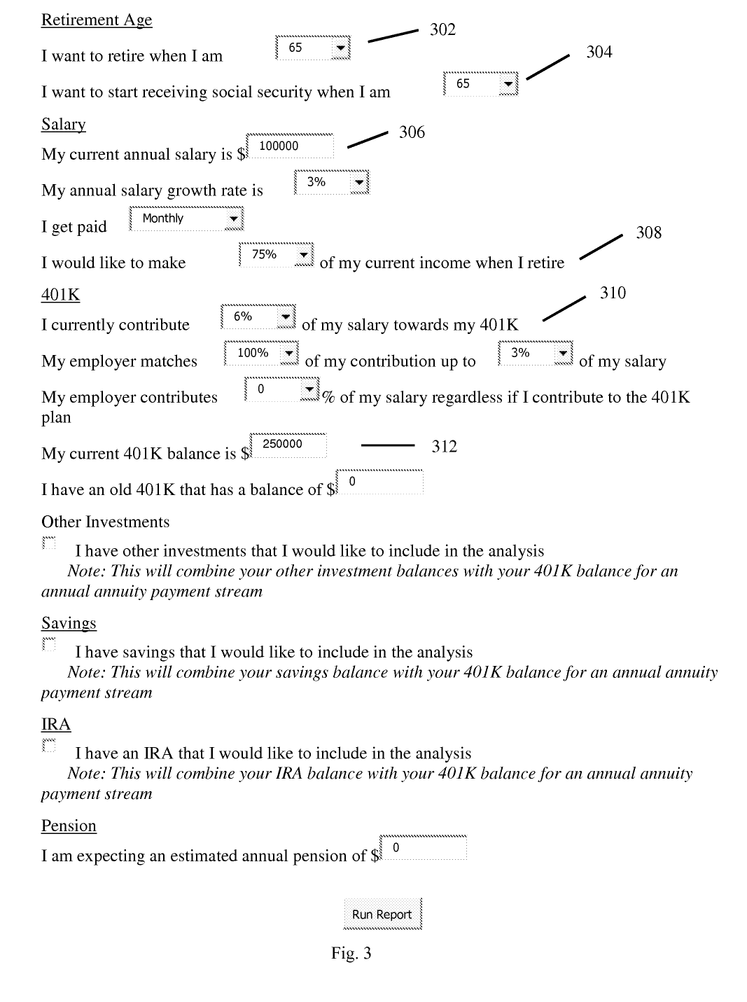

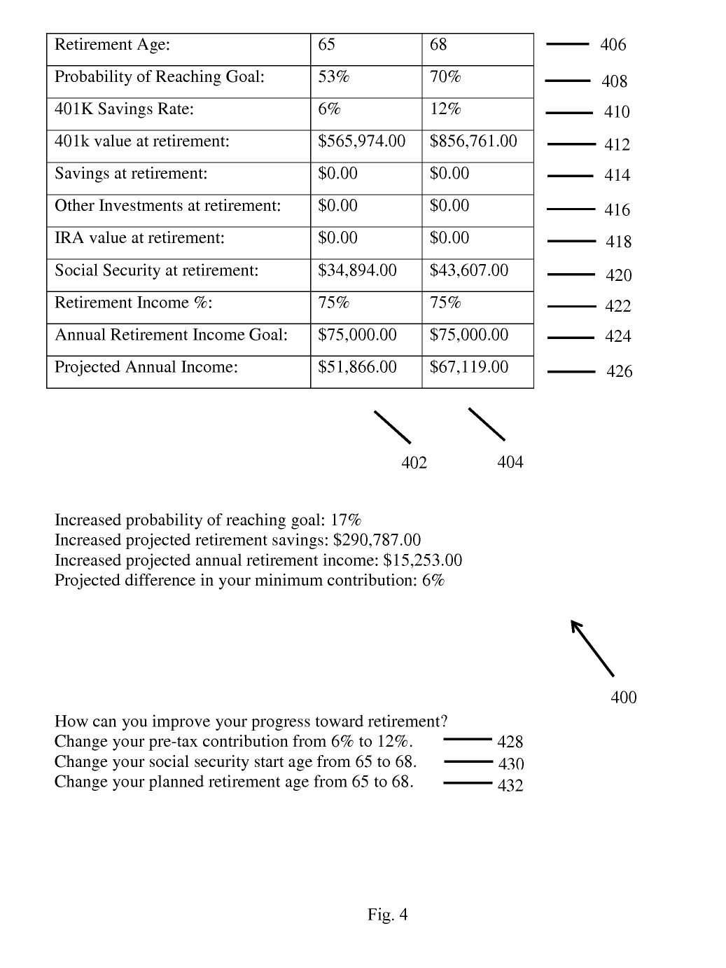

In an embodiment, a website will provide a report to the participant with the amount of retirement income that can be expected based on multiple variables. FIG. 3 depicts a website for entering information to determine how to reach retirement goals. Variables include, but are not limited to, retirement age 302, age at which begin to receive social security 304, current annual salary 306, the percentage of current income that the participant wants to receive monthly during retirement 308, contribution percentage to the participant's 401k 310, and current 401k balance 312. In an embodiment, the plan website utilizes current annuity purchase rates. In an embodiment, the plan website utilizes in its calculations the current amount of social security benefits. FIG. 3. In an embodiment, a report is provided for downloading or printing, based on the information entered on the website. FIG. 4 depicts a report 400 providing guidance on how to reach retirement goals. The report includes information regarding the current strategy 402 and the suggested strategy 404. The report can include, but is not limited to, retirement age 406, probability of reaching goal 408, 401k savings rate 410, 401k value at retirement 412, savings at retirement 414, other investments at retirement 416, IRA value at retirement 418, social security at retirement 420, retirement income percentage 422, annual retirement income goal 424, and projected annual income 426. In an embodiment, the report details suggested changes, such as changing your pre-tax contribution from 6% to 12% 428, changing your social security start age from 65 to 68 430, and changing your planned retirement age from 65 to 68 432. FIG. 4.

Qualified joint and survivor annuity rules would not be expected to apply if the participant rolls over to an individual retirement account before annuitizing. Spousal consent could be required for non-joint and survivor annuities. A reserve requirement is not expected to be required as the group trust is not an insurance contract. In an embodiment, the trust is an individual trust and a reserve requirement would not be required because it is not an insurance contract.

In an embodiment, there is no impact if the bank changes providers as long as the group trust is retained. When a participant leaves the certificate can 1) remain in the trust, 2) be transferred to a new group trust if new employer elects to include it in the plan, or 3) can rollover to IRA.

In an embodiment, the trust is an individual trust and there is no impact if the bank changes providers as long as the trust is retained. When the participant leaves, the certificate can 1) remain in the trust, 2) be transferred to a new trust if a new employer elects to include in in the plan, or 3) rollover to an IRA.

In an embodiment, a trust is not used. In an embodiment, when the participant leaves, the certificate can be transferred.

In an embodiment, in addition to the benefits to the participant, there can be benefits to the insurance company and broker of record. A benefit for the insurance company is that since it provides the guaranteed annuity purchase rates, it can retain the assets. A benefit for the broker of record is that the certificate will list the broker of record at the time the certificate is issued. Therefore, the broker will get a commission when the annuity is issued. In an embodiment, the plan can have a guaranteed floor at the time of annuitizing in which the carrier provides a guaranteed base for annuitizing the account and there is a link to the prior year's returns with a guaranteed minimum.

In an embodiment, the service allows a participant in a 401(k) plan or IRA holder to subscribe to a service. In an embodiment, the participant has paid for the service for years and when the participant wants to retire, the participant contacts the bank to purchase an annuity. In an embodiment, the bank selects an insurance company from which to buy the annuity. The service can provide the participant with an initial statement and annual statements indicating the amount of monthly income their retirement account would provide based on current annuity purchase rates.

In an embodiment, the bank provides a report to the 401k manager each year indicating the projected monthly payout to each participant at retirement in the 401k manager's plan. In an embodiment, the monthly payout that a participant is expected to receive upon retirement increases in the reports following the year 1 report. In an embodiment, the bank provides a report to the 401k manager annually. The plan relieves the 401k manager or IRA holder from having to perform due diligence on the annuity provider. In an embodiment, the bank performs due diligence on the annuity providers.

Among other advantages, the plan and its corresponding website provide 1) a shifting of investment risk to the insurance company; 2) utilization of updated social security benefit amounts in calculations; 3) use of true annuity purchase rates, instead of mortality tables or a percentage (e.g., 4%); and 4) advice to the participant regarding what actions need to be taken to meet their retirement income goal.

### EXAMPLES

### Example 1

An example of an analysis can be based on the following assumptions: current age 62; current salary $73,000; retirement income goal as a percentage of final salary 80%; desired retirement age 67; annual inflation rate 3%; 401(k) contribution 3%; salary growth rate 2%; employer contribution 2%; and a current 401(k) balance of $235,000. Participant's current paycheck is $2,129.17 if he contributes 3% to his 401(k). If the participant changed the contribution to his 401(k) to 8%, the new amount of his paycheck would be $1,989.17.

In an embodiment, the retirement income is 1) Social Security $24,325; 2) Retirement Plans $20,124; 3) Pensions $2,000 for a Total Projected Income of $46,449. The Income Goal would be $58,400. The projected value of the 401(k) would be $503,100 and the goal is $732,000. The amount that needs to be made up in time for retirement is $11,951.

### Example 2

In an embodiment, revenue projections are: First Year Revenue—500 subscribers—$50,000; Second Year Revenue—1000 new subscribers—$100,000 revenue—250 renew—$15,000—total revenue $115,000; and Third Year Revenue—2000 new subscribers—$200,000 revenue—600 renew—$36,000—total revenue—$236,000. The potential revenue, if 1% of the participants subscribe (25,000), would be revenue of $2,500,000.

### Example 3

A report of projected annual retirement income will be prepared utilizing information input into a website. A participant will access a portion of the website using a unique login and password. The participant will enter information including, but not limited to, that he wants to retire at age 65, when he wants to start receiving social security when he is 65, that his current salary is $100,000, that his annual salary growth rate is 3%, that he wants to make 75% of his current income when he retires, that he currently contributes 6% of his salary to his 401k, that his employer matches 100% of his contribution up to 3% of his salary, and that his 401k balance is $250,000. FIG. 3.

### Example 4

An example of an analysis will be prepared based on the following assumptions: retiring at age 65, a salary of $100,000, and a pre-tax contribution rate to a 401k of 6%. These assumptions result in social security at retirement of $34,894 and a projected annual income of $51,866. FIG. 4. The report suggests changing the pre-tax contribution rate to a 401k from 6% to 12%, changing the social security start age from 65 to 68, and changing the planned retirement age from 65 to 68.

All of the systems and methods disclosed and claimed herein can be made and executed without undue experimentation in light of the present disclosure. While the systems and methods of this disclosure have been described in terms of preferred embodiments, it will be apparent to those of skill in the art that variations can be applied to the systems and methods and in the steps or in the sequence of steps of the methods described herein without departing from the concept, spirit and scope of the disclosure. All such similar substitutes and modifications apparent to those skilled in the art are deemed to be within the spirit, scope and concept of the disclosure as defined by the appended claims.

What is claimed is:

1. A computer-implemented method for providing annuity benefits throughout retirement of a participant comprising
entering a participant's information into a database on a bank computer capable of sending and receiving data, wherein the bank computer is connected to a bank's computer network;
utilizing the participant's information entered into the database on the bank computer connected to the bank's computer network to perform computer-based calculations of the amount of time that the participant will need retirement funds;
determining by computer-based calculations using existing annuity purchase rates, the amount of money from the participant's existing funds needed for the purchase of an annuity that will provide an income throughout retirement of the participant in combination with any remaining existing funds of the participant;
transferring at least a portion of the participant's existing funds electronically to the bank computer connected to the bank's computer network;
obtaining an annuity commitment from an insurer; wherein annuity purchase rates were obtained electronically from at least one insurer;
providing the participant with a right to purchase the annuity at a guaranteed purchase rate; and
providing the participant with monthly retirement funds throughout retirement if the annuity was purchased.

2. The computer-implemented method of claim 1 wherein a bank acts as a fiduciary at the time of annuity purchase.

3. The computer-implemented method of claim 1 wherein the computer-based calculations to determine the amount of money from the participant's existing funds needed for the purchase of the annuity comprise life expectancy data, current retirement balance, and retirement contributions.

4. The computer implemented method of claim 1 wherein the annuity is portable.

5. The computer-implemented method of claim 1 wherein the participant is provided with an annual report.
